(19) United States
(12) Patent Application Publication
(10) Pub. No.: US 2009/0028243 A1
(43) Pub. Date: Jan. 29, 2009

(54) Method and apparatus for coding and decoding with motion compensated prediction

(76) Inventors: Mitsuru Suzuki, Gifu (JP); Shinichiro Okada, Aichi (JP)

Correspondence Address: MCDERMOTT WILL & EMERY LLP, 600 13TH STREET, N.W., WASHINGTON, DC, 20005-3096, US

(21) Appl. No.: 11/887,005

(22) PCT Filed: Feb. 17, 2006
(86) PCT No.: PCT/JP2006/302809

§ 371 Date: Sep. 24, 2007

(51) Int. Cl. H04N 7/32; H04N 7/12

(52) U.S. Cl. 375/240.15; 375/240.16; 348/699; 375/E07.106

(57) ABSTRACT

The direct mode of motion compensation will make coding efficiency worse if the motion deviates from a linear motion model. The motion vector linear prediction unit 64 assumes a motion vector of a reference macro block of a backward reference P frame, which lies in the same spatial position as a target macro block of a target B frame of a moving image, as a motion vector of the target macro block of the target B frame. The motion vector linear prediction unit 64 linearly predicts the forward motion vector and the backward motion vector of the target macro block based on the assumed motion vector. The difference vector search unit 66 determines a forward difference vector for correcting the forward motion vector and a backward difference vector for correcting the backward motion vector independently of each other. The motion compensated prediction unit 68 then performs motion compensation on the target macro block by using the forward and the backward motion vectors respectively corrected by the forward and the backward difference vectors, so as to generate a predicted image.

### TECHNICAL FIELD

The invention relates to method and apparatus for coding a moving image and also relates to method and apparatus for decoding a coded moving image.

### BACKGROUND TECHNOLOGY

With the rapid development of broadband networks, expectations are growing for services that use high quality moving images. The use of high-capacity recording media such as DVDs also contributes to increasing the number of users who enjoy high quality images. Compression coding is one of the technologies that is indispensable for transmitting moving images over communication lines and storing the same on recording media. Among the international standards for moving image compression coding technology are MPEG-4 and H.264/AVC. Furthermore, there are next-generation image compression technologies such as Scalable Video Coding (SVC), in which each single stream contains both high-quality and low-quality streams.

The moving image compression coding employs motion compensation. Japanese Patent Laid-Open Publication No. Hei 9-182083 discloses a video image coding apparatus for coding a moving image by using bidirectional motion compensation.

When streaming high-resolution moving images or storing the same on recording media, the compression rates of the moving image streams must be increased so as not to overload the communication bands and so as not to require a great deal of storing capacity. On the other hand, in order to maintain a high quality of the image, motion compensation must be made in a finer pixel resolution. For instance, motion vector search or the like will be performed in a resolution of a ¼ pixel, resulting in a large amount of coding data related to motion vectors. The increasing amount of information on the motion vectors will pose an obstacle to improving the compression ratio of the moving stream. A technology for reducing the amount of coding ascribable to the motion vector information has thus been much sought after.

### DISCLOSURE OF THE INVENTION

The present invention has been achieved in view of the foregoing and other circumstances. It is therefore a general purpose of the present invention to provide a moving image coding and decoding technology which is capable of high-precision motion prediction with high coding efficiency.

To solve the foregoing and other problems, a coding apparatus according to one of the embodiments of the present invention comprises: a motion vector linear prediction unit which linearly predicts a first motion vector and a second motion vector by using a motion vector of a block of another frame corresponding to a target block of a coding target frame, the first motion vector indicating a motion of the target block with respect to a first reference frame and the second motion vector indicating a motion of the target block with respect to a second reference frame; a difference vector search unit which searches independently a first difference vector for correcting the first motion vector and a second difference vector for correcting the second motion vector; and a motion compensated prediction unit which performs a motion compensation on the target block by using the first motion vector corrected by the first difference vector and the second motion vector corrected by the second difference vector.

Here, “a block of another frame corresponding to a target block of a coding target frame” implies not only the case where the target block of the coding target frame and the corresponding block of the another frame lies in the identical or substantially identical position on the image, but also the case where the positions of these two blocks on the image are different due to a scroll of a screen or the like, while the correspondence relation therebetween is maintained.

According to this embodiment, it is possible to improve the precision of motion compensation and reduce the amount of coding of motion vector information.

Another embodiment of the present invention relates to a data structure of a moving image stream. The data structure of the moving image stream has coded frames of a moving image, wherein a first difference vector and a second difference vector that has been variable length coded as motion vector information together with a coding target frame, the first and the second difference vectors being for independently correcting a first motion vector and a second motion vector respectively, the first and the second motion vectors being linearly predicted by using a motion vector of a block of another frame corresponding to a target block of the coding target frame, the first motion vector indicating a motion of the target block with respect to a first reference frame and the second motion vector indicating a motion of the target block with respect to a second reference frame.

Still another embodiment of the present invention relates to a decoding apparatus. The decoding apparatus for decoding a moving image stream having coded frames of a moving image, comprises: a motion vector linear prediction unit which linearly predicts a first motion vector and a second motion vector by using a motion vector of a block of another frame corresponding to a target block of a decoding target frame, the first motion vector indicating a motion of the target block with respect to a first reference frame and the second motion vector indicating a motion of the target block with respect to a second reference frame; a difference vector composition unit which obtains a first difference vector for correcting the first motion vector and a second difference vector for correcting the second motion vector from the moving image stream, adds the first difference vector to the first motion vector and adds the second difference vector to the second motion vector; and a motion compensated prediction unit which performs a motion compensation on the target block by using the first motion vector corrected by the first difference vector and the second motion vector corrected by the second difference vector.

According to this embodiment, it is possible to improve the precision of motion compensation and reproduce the moving image with a high image quality.

Still another embodiment of the present invention relates to a coding apparatus. The coding apparatus for coding frames of a moving image in compliance with MPEG or H.264/AVC standard, comprises: a motion vector linear prediction unit which linearly predicts a forward motion vector and a backward motion vector by using a motion vector of a block of a backward reference P frame that lies in a position corresponding to that of a target block of a coding target B frame, the forward motion vector indicating a forward motion of the target block with respect to a forward reference P frame and the backward motion vector indicating a backward motion of the target block with respect to the backward reference P frame; a difference vector search unit which searches independently a forward difference vector for correcting the forward motion vector and a backward difference vector for correcting the backward motion vector; and a motion compensated prediction unit which performs a motion compensation on the target block by using the forward motion vector corrected by the forward difference vector and the backward motion vector corrected by the backward difference vector.

Still another embodiment of the present invention relates to a decoding apparatus. The decoding apparatus for decoding a moving image stream having coded frames of a moving image in compliance with MPEG or H.264/AVC standard, comprises: a motion vector linear prediction unit which linearly predicts a forward motion vector and a backward motion vector by using a motion vector of a block of a backward reference P frame corresponding to a target block of a decoding target B frame, the forward motion vector indicating a forward motion of the target block to a forward reference P frame and the backward motion vector indicating a backward motion of the target block to the backward reference P frame; a difference vector composition unit which obtains a forward difference vector for correcting the forward motion vector and a backward difference vector for correcting the backward motion vector from the moving image stream, adds the forward difference vector to the forward motion vector and adds the backward difference vector to the backward motion vector; and a motion compensated prediction unit which performs a motion compensation on the target block by using the forward motion vector corrected by the forward difference vector and the backward motion vector corrected by the backward difference vector.

Still another embodiment of the present invention relates to a coding method. The coding method for performing bidirectional prediction coding on a coding target frame of a moving image by a direct mode in MPEG or H.264/AVC standard, comprises: determining a forward difference vector and a backward difference vector for independently correcting a forward motion vector and a backward motion vector respectively, the forward motion vector and the backward motion vector being linearly predicted based on a motion vector of a backward reference frame; and performing a motion compensation on the target block by using the forward motion vector corrected by the forward difference vector and the backward motion vector corrected by the backward difference vector.

Still another embodiment of the present invention relates to a decoding method. The decoding method for performing bidirectional prediction decoding on a coded frame of a moving image by a direct mode in MPEG or H.264/AVC standard, comprises: obtaining from a moving image stream a forward difference vector and a backward difference vector for independently correcting a forward motion vector and a backward motion vector respectively, the forward motion vector and the backward motion vector being linearly predicted based on a motion vector of a backward reference frame; correcting the forward and the backward motion vectors by adding the forward and the backward difference vectors to the forward and the backward motion vectors respectively; and performing a motion compensation on the target block by using the corrected forward motion vector and the corrected backward motion vector.

It should be appreciated that any combination of the foregoing components, and any conversion of expressions of the present invention from/into methods, apparatuses, systems, recording media, computer programs, and the like are also intended to constitute applicable aspects of the present invention.

### EFFECTS OF THE INVENTION

According to the present invention, the coding efficiency of a moving image can be improved and high-precision motion prediction can be achieved.

### BRIEF DESCRIPTION OF THE DRAWINGS

FIG. 1 is a block diagram of a coding apparatus according to an embodiment;

FIG. 2 is a diagram for explaining the procedure of motion compensation in a normal direct mode;

FIG. 3 is a diagram for explaining the configuration of the motion compensation unit of FIG. 1;

FIG. 4 is a diagram for explaining the procedure of motion compensation in an improved direct mode;

FIG. 5 is a block diagram of a decoding apparatus according to an embodiment; and

FIG. 6 is a block diagram of the motion compensation unit of FIG. 5.

### DESCRIPTION OF REFERENCE NUMERALS

10 block generating unit, 12 subtractor, 14 adder, 20 DCT unit, 30 quantization unit, 40 inverse quantization unit, 50 inverse DCT unit, 60 motion compensation unit, 61 motion vector holding unit, 64 motion vector linear prediction unit, 66 difference vector search unit, 68 motion compensated prediction unit, 80 frame buffer, 90 variable length coding unit, 100 coding apparatus, 201 forward reference P frame, 203 target B frame, 204 backward reference P frame.

### THE BEST MODE FOR CARRYING OUT THE INVENTION

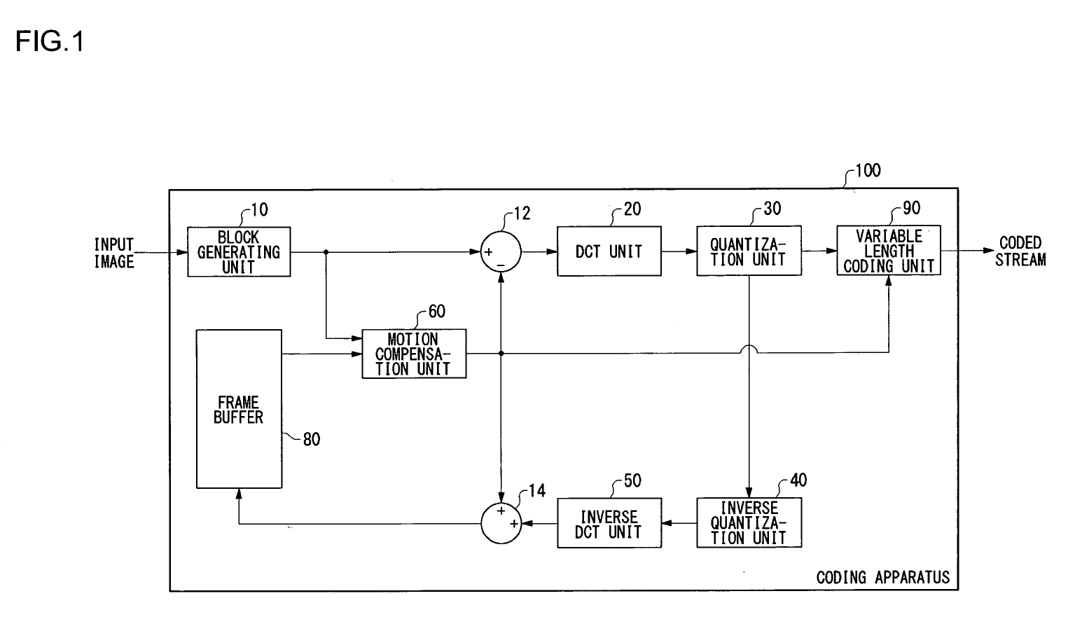

FIG. 1 is a block diagram of a coding apparatus 100 according to a first embodiment. In terms of hardware, this configuration can include an arbitrary computer CPU, a memory, and other LSIs. In terms of software, it can be achieved by a program or the like that can be loaded into a memory and can have image coding functions. The functional blocks shown in the diagram are realized by the cooperation of these hardware and software components. It should therefore be understood by those skilled in the art that these functional blocks may be practiced in various forms including hardware alone, software alone, and combinations of these forms.

The coding apparatus 100 according to the present embodiment performs moving image coding in compliance with any of the following: the MPEG (Moving Picture Experts Group) series of standards (MPEG-1, MPEG-2 and MPEG-4), standardized by the international standardization institute ISO (International Organization for Standardization)/IEC (International Electrotechnical Commission); the H.26x series of standards (H.261, H.262 and H.263), standardized by the international standardization institute for telecommunication ITU-T (International Telecommunication Union-Telecommunication Standardization Sector); and the latest moving image compression coding standard H.264/AVC, standardized by the cooperation of the two standardization institutes (the official names of the recommendation in the respective institutes are MPEG-4 Part 10: Advanced Video Coding and H.264).

According to the MPEG series of standards, image frames intended for intraframe coding are called I (Intra) frames. Image frames intended for forward interframe predictive coding, using past frames as reference images, are called P (Predictive) frames. Image frames intended for bidirectional interframe coding, using past and future frames as reference images, are called B frames.

According to H.264/AVC, in contrast, frames may be used as reference images irrespective of temporal sequence. Two past frames may be used as reference images, and two future frames as well. The number of frames available for reference images is not limited, either. Three or more frames may be used as reference images. Thus, it should be noted that while B frames in the MPEG-1/2/4 refer to Bi-directional prediction frames, B frames in H.264/AVC refer to Bi-predictive prediction frames since the temporal sequence of the reference images does not matter.

Note that, in the present specification, the term “frame” has the same meaning as that of the term “picture”. Specifically, the “I frame”, “P frame”, and “B frame” will also be referred to as the “I picture”, “P picture”, and “B picture”, respectively.

The coding apparatus 100 receives input of a moving image frame by frame, codes the moving image, and outputs a coded stream.

A block generating unit 10 divides an input image frame into macro blocks. Macro blocks are generated from the top left to the bottom right of the image frame in succession. The block generating unit 10 supplies the generated macro blocks to a subtractor 12 and a motion compensation unit 60.

If the image frame supplied from the block generating unit 10 is an I frame, the subtractor 12 simply outputs the frame to a DCT unit 20. If the image frame is a P frame or B frame, the subtractor 12 calculates a difference from a predicted image supplied from the motion compensation unit 60, and supplies it to the DCT unit 20.

Using past or future image frames stored in a frame buffer 80 as reference images, the motion compensation unit 60 makes motion compensation on each of the macro blocks of the P or B frame input from the block generating unit 10, thereby generating motion vectors and a predicted image. The motion compensation unit 60 supplies the generated motion vectors to a variable length coding unit 90, and supplies the predicted image to the subtractor 12 and an adder 14.

The subtractor 12 determines a difference between the current image output from the block generating unit 10 and the predicted image output from the motion compensation unit 60, and outputs it to the DCT unit 20. The DCT unit 20 performs discrete cosine transform (DCT) on the difference image supplied from the differentiator 12, and supplies DCT coefficients to a quantization unit 30.

The quantization unit 30 quantizes the DCT coefficients, and supplies the resultant to the variable length coding unit 90. The variable length coding unit 90 performs variable length coding on the motion vectors supplied from the motion compensation unit 60 and the quantized DCT coefficients of the difference image as well, thereby generating a coded stream. When generating the coded stream, the variable length coding unit 90 performs processing for sorting the coded frames in time order.

The quantization unit 30 supplies the quantified DCT coefficients of the image frame to an inverse quantization unit 40. The inverse quantization unit 40 inversely quantizes the supplied quantization data, and supplies the resultant to an inverse DCT unit 50. The inverse DCT unit 50 performs inverse discrete cosine transform on the supplied inverse quantization data. This restores the coded image frame. The restored image frame is input to the adder 14.

If the image frame supplied from the inverse DCT unit 50 is an I frame, the adder 14 simply stores the image frame into a frame buffer 80. If the image frame supplied from the inverse DCT unit 50 is a P frame or B frame, i.e., a difference image, the adder 14 adds the difference image supplied from the inverse DCT unit 50 to the predicted image supplied from the motion compensation unit 60, thereby reconstructing the original image frame. The reconstructed image frame is stored into the frame buffer 80.

In the processing of coding a P or B frame, the motion compensation unit 60 performs operations as described above. In the processing of coding an I frame, on the other hand, the motion compensation unit 60 performs no operation and an intraframe prediction is performed (not shown).

When making motion compensation on a B frame, the motion compensation unit 60 operates in an improved direct mode. The standards MPEG-4 and H.264/AVC provide a direct mode for B-frame motion compensation, and an improved version of which is the improved direct mode.

For the sake of comparison, the normal direct mode will be described first. Then, the improved direct mode of the present embodiment will be described.

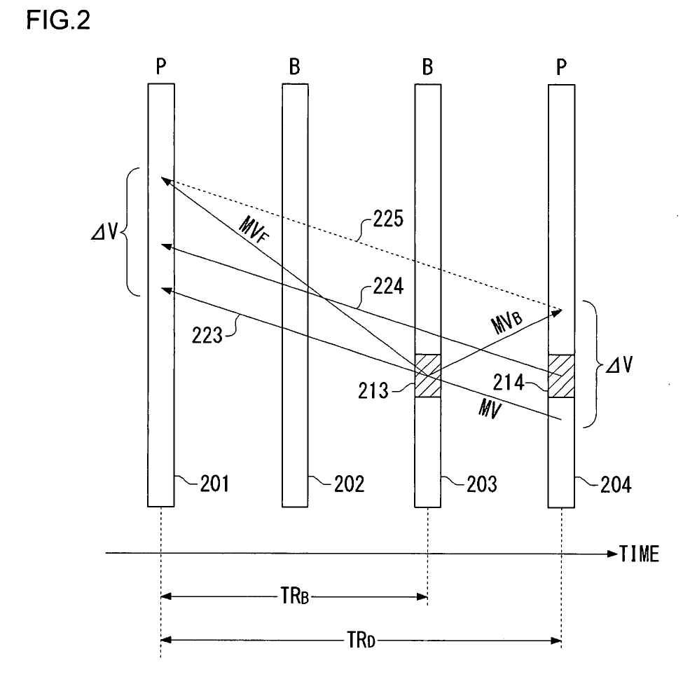

FIG. 2 is a diagram for explaining the procedure of motion compensation in the normal direct mode. In the direct mode, one motion vector is linearly interpolated in a forward direction and a backward direction based on a linear motion model, thereby providing the effect of bidirectional prediction.

The diagrams show four frames in order of display time, with the lapse of time shown from left to right. P frame 201, B frame 202, B frame 203, and P frame 204 are displayed in this order. The frames are coded in an order that is different from the order of display. The first P frame 201 in the diagrams is initially coded. Then, the fourth P frame 204 is coded with motion compensation using the first P frame 201 as a reference image. Subsequently, the B frame 202 and the B frame 203 are each coded with motion compensation using the preceding and subsequent two P frames 201 and 204 as reference images. It should be appreciated that the first P frame in the diagrams may be an I frame. The fourth P frame in the diagrams may also be an I frame. In this case, the motion vector of the corresponding block in the I frame is handled as (0, 0).

Suppose that the two P frames 201 and 204 are already coded, and the B frame 203 is to be coded now. This B frame 203 will be referred to as a target B frame. The P frame 4 to be displayed after the target B frame will be referred to as a backward reference P frame, and the P frame 1 to be displayed before the target B frame will be referred to as a forward reference P frame.

In bidirectional prediction mode, the target B frame 203 is predicted bidirectionally based on the two frames, i.e., the forward reference P frame 201 and the backward reference P frame 204. As a result, a forward motion vector MV_{F} for indicating motion with respect to the forward reference P frame 201 and a backward motion vector MV_{B} for indicating motion with respect to the backward reference P frame 204 are determined independently, whereby two motion vectors are generated. In the direct mode, the target B frame 203 is similarly predicted bidirectionally based on the two frames, or the forward reference P frame 201 and the backward reference P frame 204. There is a difference, however, in that both the forward and backward motion vectors are linearly predicted from a single motion vector.

In the direct mode, the assumption is given that the motion vector (numeral 224) previously determined with respect to the reference macro block 214 of the backward reference P frame 204, lying in the same spatial position as a target macro block 213 of the target B frame 203, is also a motion vector MV (numeral 223) of the target macro block 213 of the target macro B frame 203. This motion vector MV is internally divided at the ratio of time intervals between frames according to the following equations so that the forward motion vector MV_{F} and the backward motion vector MV_{B} of the target macro block 213 of the target B frame 203 are obtained.

MV_{F}=(TR_{B}×MV)/TR_{D}

MV_{B}=(TR_{B}−TR_{D})×MV/TR_{D}

Here, TR_{B} is the time interval from the forward reference P frame 201 to the target B frame 203, and TR_{D} is the time interval from the forward reference P frame 201 to the backward reference P frame 204.

The direct mode is based on the linear motion model in which the motion speed is constant, however, the motion speed is not necessarily constant. Therefore the forward motion vector MV_{F} and the backward motion vector MV_{B} are corrected by the following equations using a difference vector ΔV that indicates a difference between the linearly predicted moving position of the target macro block 213 and the actual moving position of the same.

MV_{F}′=(TR_{B}×MV)/TR_{D}+ΔV

MV_{B}′=(TR_{B}−TR_{D})×MV/TR_{D}−ΔV

Note that the diagrams show two-dimensional images in a one-dimensional fashion. However, the difference vector ΔV has horizontal and vertical two-dimensional components corresponding to the fact that the motion vectors have horizontal and vertical two-dimensional image components.

In the direct mode, the common difference vector ΔV is used for both the forward motion vector MV_{F}′ and the backward motion vector MV_{B}′. Therefore, it should also be noted that the motion vector (numeral 225) for indicating the motion from the reference position in the backward reference P frame 204, given by the backward motion vector MV_{B}′, to the reference position in the forward reference P frame 201, given by the forward motion vector MV_{F}′, lies in parallel with the motion vector (numeral 224) of the reference macro block 214 of the backward reference P frame 204, i.e., the assumed motion vector MV (numeral 223) of the target macro block 213 of the target B frame 203. In other words, the motion vectors are unchanged in gradient.

In the direct mode, the forward motion vector MV_{F}′ and the backward motion vector MV_{B}′ thus corrected by the common difference vector ΔV are used to make motion compensation on the target macro block 213 and generate a predicted image. The motion vector information in the direct mode is the motion vector MV and the difference vector ΔV. If it is compared with the bidirectional prediction, the motion vector information in the bidirectional prediction is two mutually independent vectors, i.e., the forward motion vector MV_{F} and the backward motion vector MV_{B}.

Consider now the amounts of coding of the motion vectors. For bidirectional prediction, the forward and backward motion vectors are detected separately so that the differences from the reference images become smaller. The amount of coding of the motion vector information is higher, however, since the information on the two independent motion vectors is coded. The recent high-quality compression coding often includes motion vector search in ¼ pixel resolution, which causes a further increase in the amount of coding of the motion vector information.

In the direct mode, on the other hand, the forward and backward motion vectors are linearly predicted by using a motion vector of the backward reference P frame 204. This eliminates the need for the coding of the motion vectors and the information on the difference vector ΔV alone has to be coded. In addition, the value of the difference vector ΔV decreases as the actual motion approaches a linear motion.

If the actual motion can be approximated with a linear motion model, then the amount of coding of the difference vector ΔV is sufficiently small.

Nevertheless, as described with reference to FIG. 2, the motion vector (numeral 225) for indicating the motion from the reference position in the backward reference P frame 204, given by the backward motion vector MV_{B}′, to the reference position in the forward reference P frame 201, given by the forward motion vector MV_{F}′ has the same gradient as the assumed motion vector (numeral 223) of the target macro block 213 of the target B frame 203 has. Consequently, if the motion deviates from the approximation given by the linear motion model, the error of the difference from the forward reference P frame 201 and the backward reference P frame 204 will become large resulting in an increase in the amount of coding. The direct mode provides a high coding efficiency if the target B frame 203 that is a bidirectional predicted image is correlated with the P frame 204 that is a backward reference image. If not, the direct mode tends to show a drop in coding efficiency because of the error of the difference.

As described above, while the direct mode is superior to bidirectional prediction mode in terms of coding efficiency, the amount of coding can possibly grow if the motion deviates from the approximation based on the linear motion model. Thus, the applicant has reached the understanding that there is room for improvement in at least these aspects. Hereinafter, description will be given of the “improved direct mode,” or an improved version of the direct mode.

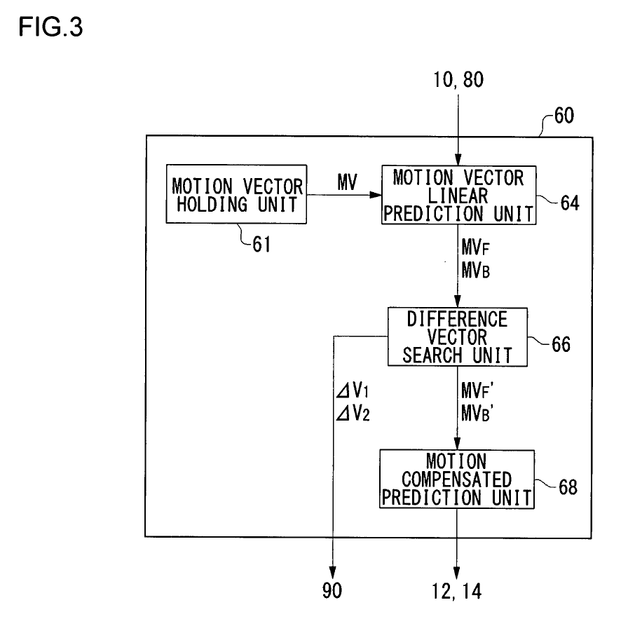

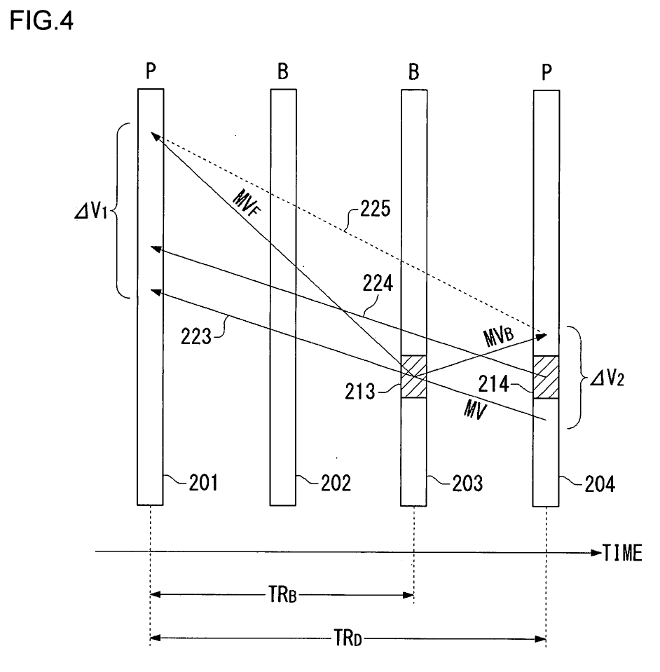

FIG. 3 is a diagram for explaining the configuration of the motion compensation unit 60. Description will be given of the procedure by which the motion compensation unit 60 performs the direct mode, by also referring to FIG. 4. FIG. 4 depicts the motion compensation in the improved direct mode using the same numerals as in FIG. 2 which explains the motion compensation in the normal direct mode. Description will be omitted where common to FIG. 2.

The motion compensation unit 60 has already detected the motion vector of each macro block of the backward reference P frame 204 when it performed the motion compensation on the backward reference P frame 204. The motion compensation unit 60 stores the detected motion vector information of the backward reference P frame 204 into the motion vector holding unit 61.

Referring to the motion vector information of the backward reference P frame 204 in the motion vector holding unit 61, the motion vector linear prediction unit 64 obtains the motion vector (numeral 224) of the reference macro block 214 of the backward reference P frame 204 that lies in the same spatial position as the target macro block 213 of the target B frame 203 and then assumes the obtained motion vector as the motion vector MV (numeral 223) of the target macro block 213 of the target B frame 203.

As in the direct mode, the motion vector linear prediction unit 64 linearly predicts the forward motion vector MV_{F} and the backward motion vector MV_{B} of the target macro block 213 of the target B frame 203 based on the assumed motion vector MV of the target macro block 213 of the target B frame 203.

The motion vector MV of the reference macro block 214 of the backward reference P frame 204 indicates the moving amount and direction of the reference macro block 214 for the duration of the time difference TR_{D} between the backward reference P frame 204 and the forward reference P frame 201. Therefore, according to the linear motion model, it can be predicted that the target macro block 213 of the target B frame 203 will show the motion of MV×(TR_{B}/TR_{D}) for the duration of the time difference TR_{B} between the target B frame 203 and the forward reference P frame 201. Therefore, the motion vector linear prediction unit 64 determines the forward motion vector MV_{F} according to the following equation.

MV_{F}=(TR_{B}×MV)/TR_{D}

Likewise, it can be predicted that the target macro block 213 of the target B frame 203 will show the motion of −MV×(TR_{B}−TR_{D})/TR_{D} for the duration of the time difference (TR_{D}−TR_{B}) between the target B frame 203 and the backward reference P frame 204. Therefore, the motion vector linear prediction unit 64 determines the backward motion vector MV_{B} according to the following equation.

MV_{B}=(TR_{B}−TR_{D})×MV/TR_{D}

The motion vector linear prediction unit 64 supplies the forward motion vector MV_{F} and the backward motion vector MV_{B} thus determined to the difference vector search unit 66.

Next, the difference vector search unit 66 determines the difference vectors ΔV₁ and ΔV₂ independently of each other for correcting the forward motion vector MV_{F} and the backward motion vector MV_{B} respectively that have been obtained by the motion vector linear prediction unit 64.

The actual motion of the target macro block 213 of the target B frame 203 will deviate from the linearly predicted one based on the motion of the reference macro block 214 of the backward reference P frame 204. For this reason, the difference vector search unit 66 searches the actual forward motion and the actual backward motion of the target macro block 213.

The difference search unit 66 determines the forward difference vector ΔV₁ that indicates the difference between the forward prediction macro block of the target macro block 213, linearly predicted by the forward motion vector MV_{F}, and the actual forward moving position. Likewise, the difference search unit 66 determines the backward difference vector ΔV₂ that indicates the difference between the backward prediction macro block of the target macro block 213, linearly predicted by the backward motion vector MV_{B}, and the actual backward moving position.

The difference search unit 66 corrects the forward motion vector MV_{F} by using the forward difference vector ΔV₁ and corrects the backward motion vector MV_{B} by using the backward difference vector ΔV₂ according to the following equations. The difference search unit 66 then supplies the corrected forward motion vector MV_{F}′ and backward motion vector MV_{B}′ to the motion compensated prediction unit 68.

MV_{F}′=(TR_{B}×MV)/TR_{D}+ΔV₁

MV_{B}′=(TR_{B}−TR_{D})×MV/TR_{D}−ΔV₂

The motion compensated prediction unit 68 then performs motion compensation on the target macro block 213 by using the forward motion vector MV_{F}′ and the backward motion vector MV_{B}′ respectively corrected by the forward difference vector ΔV₁ and the backward difference vector ΔV₂, so as to generate a predicted image. The motion compensated prediction unit 68 supplies the predicted image to the subtractor 12 and the adder 14.

The motion vector information in the improved direct mode includes the motion vector MV, the forward difference vector ΔV₁ and the backward difference vector ΔV₂ and the latter two to be coded are supplied from the difference vector search unit 66 to the variable length coding unit 90.

As shown in FIG. 4, in the improved direct mode, the forward difference vector ΔV₁ for correcting the forward motion vector MV_{F} and the backward difference vector ΔV₂ for correcting the backward motion vector MV_{B} are defined independently of each other. Consequently, the gradient of the motion vector (numeral 225) indicating the motion from the reference position of the backward reference P frame 204, given by the corrected backward motion vector MV_{B}′, to the reference position of the forward reference P frame 201, given by the corrected forward motion vector MV_{F}′ can differ from that of the assumed motion vector MV (numeral 223) of the target macro block 213 of the target B frame 203. Therefore, even if the motion deviates from the approximation based on the linear motion model, the improved direct mode can correct the forward motion vector MV_{F} and the backward motion vector MV_{B} independently so as to prevent the error of the difference from the forward reference P frame 201 and the backward reference P frame 204 from growing further.

As described above, the coding apparatus 100 according to the present embodiment in the improved direct mode provides the two difference vectors ΔV₁, ΔV₂ for the motion vector MV of the backward reference P frame 204 used in the normal direct mode. Accordingly, when compared to the normal direct mode, the amount of the motion vector information increases by the amount of one difference vector, while the error of the difference from the reference images decreases due to the use of the two difference vectors. As a result, the total amount of coding can be reduced.

When further compared to the bidirectional prediction mode, the amount of coding based on the error of the difference from the reference images in the improved direct mode will be the same theoretically. However, the amount of coding the motion vector information will become equal to or less than that of coding the motion vector information in the bidirectional prediction mode. While the motion vector information includes the two independent forward and backward motion vectors in the bidirectional prediction, the motion vector information includes the motion vector of the backward reference frame and the two difference vectors. If there is a strong correlation between the bidirectional prediction image and the backward reference image, the approximation accuracy of the linear motion model will increase and therefore the two difference vectors will have small values in the improved direct mode.

In addition, the higher the resolution of the image is, the larger the size of the motion vector becomes, resulting in an increasing ratio of the motion vector information occupied in the total amount of coding. Accordingly, due to the merit that the amount of coding of the motion vector information is small in the improved direct mode, the efficiency of coding can be further improved when compared to the other modes.

From the perspective of the image quality of the coded moving image, since the coding apparatus 100 according to the present invention corrects the forward motion vector MV_{F} and the backward motion vector MV_{B} of the target B frame independently of each other by using the forward difference vector ΔV₁ and the backward difference vector ΔV₂ respectively, the apparatus 100 can perform a highly accurate motion compensation, thereby enhancing the image quality. If the target B frame and the backward reference P frame are highly correlated, in other words, if the linearity is highly preserved when the change is seen in the temporal direction, the linear motion model will work effectively. Even if the motion deviates from the temporal linearity to a certain degree, however, the forward motion vector MV_{F} and the backward motion vector MV_{B} are independently corrected so that a high accuracy can be maintained and the degradation in the image quality due to the deviation from the temporal linearity can be avoided.

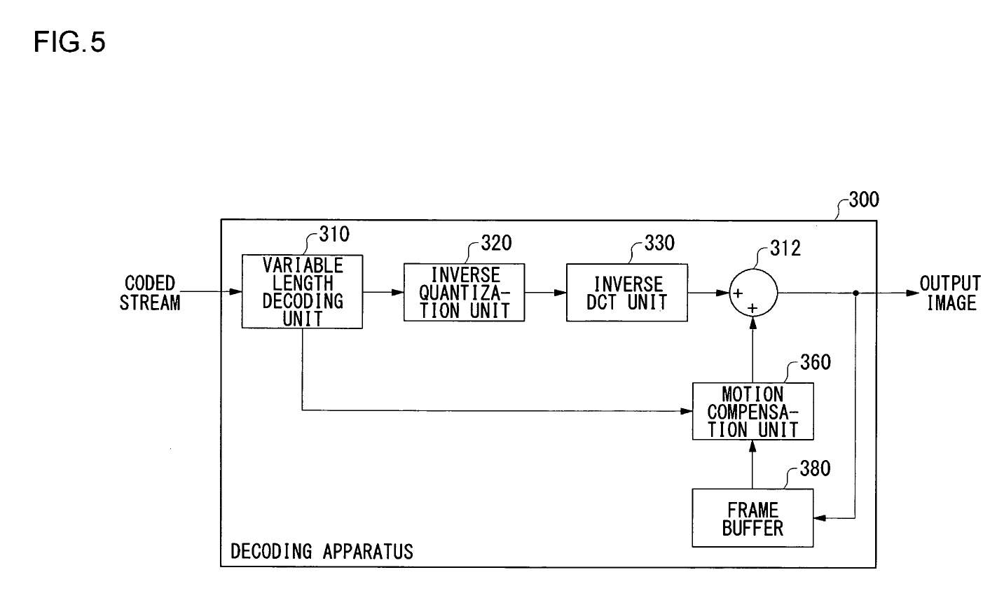

FIG. 5 is a block diagram of a decoding apparatus 300 according to an embodiment. The functional blocks may also be achieved in various forms including hardware alone, software alone, and a combination of these forms.

The decoding apparatus 300 receives input of a coded stream and decodes the coded stream to generate an output image.

A variable length decoding unit 310 performs variable decoding on the input coded stream, supplies the decoded image data to an inverse quantization unit 320, and supplies motion vector information to a motion compensation unit 360.

The inverse quantization unit 320 inversely quantizes the image data decoded by the variable length decoding unit 310, and supplies the resultant to an inverse DCT unit 330. The image data inversely quantized by the inverse quantization unit 320 includes DCT coefficients. The inverse DCT unit 330 performs inverse discrete cosine transform (IDCT) on the DCT coefficients that are inversely quantized by the inverse quantization unit 320, thereby restoring the original image data. The image data restored by the inverse DCT unit 330 is supplied to an adder 312.

If the image data supplied from the inverse DCT unit 330 is an I frame, the adder 312 simply outputs the image data of the I frame as well as stores it into a frame buffer 380 as a reference image for generating a predicted image such as a P frame and a B frame.

If the image frame supplied from the inverse DCT unit 330 is a P frame, i.e., a difference image, the adder 312 adds the difference image supplied from the inverse DCT unit 330 and the predicted image supplied from the motion compensation unit 360. The adder 14 thereby reconstructs the original image frame for output.

The motion compensation unit 360 generates a P frame or B frame, i.e., a predicted image by using the motion vector information supplied from the variable length decoding unit 310 and the reference images stored in the frame buffer 380. The generated predicted image is supplied to the adder 312. Description will now be given of the configuration and operation of the motion compensation unit 360 for decoding a B frame that has been coded in the improved direct mode.

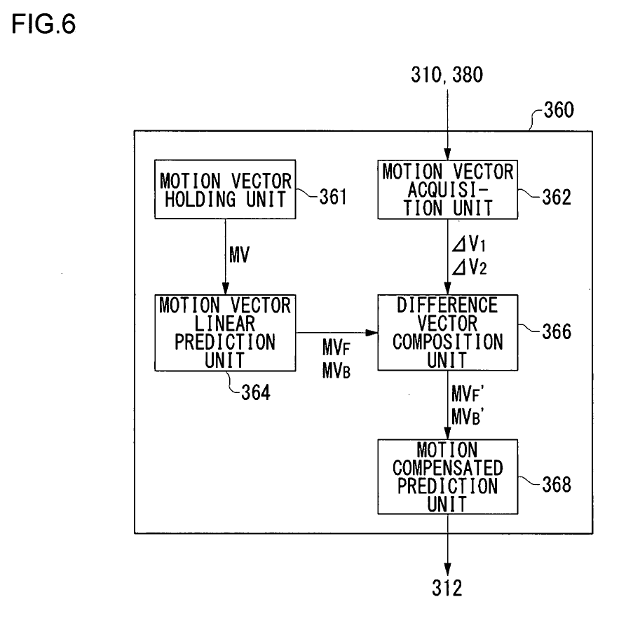

FIG. 6 is a block diagram of the motion compensation unit 360. The motion compensation unit 360 has already detected the motion vector of each macro block of the backward reference P frame when it performed the motion compensation on the backward reference P frame. The motion compensation unit 360 stores the detected motion vector information of the backward reference P frame into the motion vector holding unit 361.

The motion vector acquisition unit 362 acquires the motion vector information from the variable length decoding unit 310. This motion vector information includes the forward difference vector ΔV₁ and the backward difference vector ΔV₂. The motion vector acquisition unit 362 supplies these two difference vectors ΔV₁, ΔV₂ to the difference vector composition unit 366.

Referring to the motion vector information of the backward reference P frame in the motion vector holding unit 361, the motion vector linear prediction unit 364 obtains the motion vector of the reference macro block of the backward reference P frame that lies in the same spatial position as the target macro block of the target B frame and then assumes the obtained motion vector as the motion vector MV of the target macro block of the target B frame.

The motion vector linear prediction unit 364 linearly predicts the forward motion vector MV_{F} and backward motion vector MV_{B} of the macro block of the target B frame by performing linear interpolation on the motion vector MV.

The difference vector composition unit 366 generates the corrected forward motion vector MV_{F}′ by adding the forward difference vector ΔV₁ to the linearly predicted forward motion vector MV_{F}. Likewise, the difference vector composition unit 366 generates the corrected backward motion vector MV_{B}′ by adding the backward difference vector ΔV₂ to the linearly predicted backward motion vector MV_{F}. The difference vector composition unit 366 then supplies the corrected forward motion vector MV_{F}′ and backward motion vector MV_{B}′ to the motion compensated prediction unit 368.

The motion compensated prediction unit 368 generates the predicted image for the B frame by using the corrected forward motion vector MV_{F}′ and the corrected backward motion vector MV_{B}′ and outputs the predicted image to the adder 312.

Since the decoding apparatus 300 according to the present invention corrects the forward motion vector MV_{F} and the backward motion vector MV_{B} by using the forward difference vector ΔV₁ and the backward difference vector ΔV₂ respectively, the apparatus 300 can improve the accuracy of the motion compensation and can reproduce the moving image with a high image quality.

The present invention has been described in conjunction with the embodiment thereof. The embodiments have been given solely by way of illustration. It should be understood by those skilled in the art that various modifications may be made to combinations of the foregoing components and processes, and all such modifications are also intended to fall within the scope of the present invention.

The foregoing description has dealt with the improved direct mode, or an improved version of the direct mode, in which a motion compensation on a B frame is made by bidirectional prediction using P frames preceding and subsequent in display time. The improved direct mode to be effected by the motion compensation unit 60 of the coding apparatus 100 according to the embodiment is not necessarily limited to the use of temporally-preceding and subsequent reference images. Two past P frames or two future P frames may be used for the linear prediction so that the correction is similarly made by using two difference vectors.

The foregoing description is given that the linear prediction is performed by using the motion vector of the reference macro block of the backward reference P frame 204 that lies in the identical position as the target macro block of the target B frame. The target macro block and the reference macro block does not necessarily lie in the identical position on the image. The pixel position will change, for instance, when the screen is scrolled. In this case the position of the target macro block on the image is different from that of the reference macro block, but the correspondence relation therebetween is maintained. When the motion vector of the reference block is assumed as the motion vector of the target macro block, it will be sufficient that there is some sort of correspondence relation between the target macro block and the reference macro block.

### INDUSTRIAL APPLICABILITY

The present invention can be applied to a moving image coding/decoding process.

1. A coding apparatus for coding frames of a moving image comprising:
a motion vector linear prediction unit which linearly predicts a first motion vector and a second motion vector by using a motion vector of a block of another frame corresponding to a target block of a coding target frame, the first motion vector indicating a motion of the target block with respect to a first reference frame and the second motion vector indicating a motion of the target block with respect to a second reference frame;
a difference vector search unit which searches independently a first difference vector for correcting the first motion vector and a second difference vector for correcting the second motion vector; and
a motion compensated prediction unit which performs a motion compensation on the target block by using the first motion vector corrected by the first difference vector and the second motion vector corrected by the second difference vector.

2. The coding apparatus according to claim 1, wherein the first and the second reference frames are frames preceding and subsequent to the target frame in display time.

3. The coding apparatus according to claim 1, further comprising a variable length coding unit which performs variable length coding on the first and the second difference vectors as motion vector information together with the coding target frame.

4. The coding apparatus according to claim 1, wherein the target block of the coding target frame and the corresponding block of said another frame lie in the identical position on the image.

5. The coding apparatus according to claim 1, wherein said another frame is any one of the first reference frame and the second reference frame.

6. The coding apparatus according to claim 1, wherein said another frame is a backward reference frame.

7. A data structure of a moving image stream having coded frames of a moving image, wherein a first difference vector and a second difference vector that has been variable length coded as motion vector information together with a coding target frame, the first and the second difference vectors being for independently correcting a first motion vector and a second motion vector respectively, the first and the second motion vectors being linearly predicted by using a motion vector of a block of another frame corresponding to a target block of the coding target frame, the first motion vector indicating a motion of the target block with respect to a first reference frame and the second motion vector indicating a motion of the target block with respect to a second reference frame.

8. A decoding apparatus for decoding a moving image stream having coded frames of a moving image, comprising:
a motion vector linear prediction unit which linearly predicts a first motion vector and a second motion vector by using a motion vector of a block of another frame corresponding to a target block of a decoding target frame, the first motion vector indicating a motion of the target block with respect to a first reference frame and the second motion vector indicating a motion of the target block with respect to a second reference frame;
a difference vector composition unit which obtains a first difference vector for correcting the first motion vector and a second difference vector for correcting the second motion vector from the moving image stream, adds the first difference vector to the first motion vector and adds the second difference vector to the second motion vector; and
a motion compensated prediction unit which performs a motion compensation on the target block by using the first motion vector corrected by the first difference vector and the second motion vector corrected by the second difference vector.

9-12. (canceled)

13. A coding method for performing bidirectional prediction coding on a coding target frame of a moving image by a direct mode in MPEG or H.264/AVC standard, comprising:
determining a forward difference vector and a backward difference vector for independently correcting a forward motion vector and a backward motion vector respectively, the forward motion vector and the backward motion vector being linearly predicted based on a motion vector of a backward reference frame; and
performing a motion compensation on the target block by using the forward motion vector corrected by the forward difference vector and the backward motion vector corrected by the backward difference vector.

14. The coding method according to claim 13, further comprising performing variable length coding on the forward and the backward difference vectors as motion vector information together with the coding target frame.

15. A decoding method for performing bidirectional prediction decoding on a coded frame of a moving image by a direct mode in MPEG or H.264/AVC standard, comprising:
obtaining from a moving image stream a forward difference vector and a backward difference vector for independently correcting a forward motion vector and a backward motion vector respectively, the forward motion vector and the backward motion vector being linearly predicted based on a motion vector of a backward reference frame;
correcting the forward and the backward motion vectors by adding the forward and the backward difference vectors to the forward and the backward motion vectors respectively; and
performing a motion compensation on the target block by using the corrected forward motion vector and the corrected backward motion vector.
